(19) United States
(12) Patent Application Publication
(10) Pub. No.: US 2019/0297840 A1
(43) Pub. Date: Oct. 3, 2019

(54) Livestock Squeeze Chute with Electronic Over Hydraulic Operating System

(71) Applicant: Rex R. Coulter, Tyler, TX (US)

(72) Inventor: Rex R. Coulter, Tyler, TX (US)

(21) Appl. No.: 16/367,681

(22) Filed: Mar. 28, 2019

Related U.S. Application Data
(60) Provisional application No. 62/649,036, filed on Mar. 28, 2018.

(51) Int. Cl. A01K 1/06; A01K 29/00

(52) U.S. Cl. CPC A01K 1/0613; A61D 2003/003; A01K 29/005

(57) ABSTRACT

A hydraulic control system for a cattle squeeze chute includes a solenoid/valve block in hydraulic communication with a hydraulic pump and electronically coupled to a user control unit. Upon receiving a user initiated input signal from the user control unit, the solenoid/valve block activates the proper solenoid to control a squeeze panel, head gate or other moving component of the cattle squeeze chute.

### CROSS-REFERENCE TO RELATED APPLICATIONS

The present application claims priority from, and incorporates by reference in its entirety, provisional U.S. patent application 62/649,036 filed Mar. 28, 2018.

### BACKGROUND

### Technical Field

Various embodiments of the present invention are drawn to livestock handling equipment, and more specifically, to large animal squeeze chutes including cattle chutes.

### Description of Related Art

It is sometimes necessary to restrain an animal in order to attach an identification tag, apply medicine or perform some other animal husbandry procedure. Typical animal husbandry procedures include vaccination, feeding pills or medicine, dehorning, castration, weighing, branding, attaching eartags or other identification units, doctoring, examination and sorting. Mechanical squeeze chutes have long been used to restrain livestock in order to perform the requisite animal husbandry procedures. The restraint consists of keeping the animal still and safe to administer typical procedures.

FIG. 1 depicts a conventional squeeze chute suitable for restraining livestock such as cattle or horses. A heifer, bull or steer enters the open gate at the rear of the squeeze chute. Once the animal sticks its head through the head gate the user can close the head gate around the animal's head. The user can also operate the squeeze chute to tighten the walls against the animal's sides, effectively restraining it so that it won't injure itself or the user. The cattle chute shown in FIG. 1 is manually operated with levers for operating the head gate and squeeze chute. Due to the size and strength of cattle and horses hydraulic squeeze chutes have become a favored means of restraining the animals. Hydraulic cylinders are used to operate the head gate and squeeze panels instead of operating them manually with levers.

U.S. Pat. No. 6,609,480 to Daniels, et al. (“Daniels '480 patent”) describes a conventional hydraulic squeeze chute for livestock. Hydraulic squeeze chutes have at least one hydraulic cylinder attached to a moveable side panel of the chute that squeezes the animal between the other side panel of the chute to restrain the animal. A hydraulic squeeze chute may also have a head gate or other mechanism operated with a hydraulic cylinder to catch the animal's head and restrain it as well. The Daniels '480 patent describes a cattle squeeze chute with a mechanism for immobilizing the animal's head. The moving parts of the cattle squeeze chute in the Daniels '480 patent operate through the use of hydraulic valves that may be manually opened and closed by the user. The use of manually operated hydraulic valves to control the operation of the chute is typical for convention livestock squeeze chutes.

### BRIEF SUMMARY

The present inventor recognized a number of advantages and benefits in his novel livestock chute design that are not realized in the design of conventional livestock chutes. For example, the present inventor recognized certain advantages to be gained through the use of electrical over hydraulic controls to operate the moving parts of a livestock chute rather than the manually operated mechanical hydraulic valves relied upon in the conventional devices. The various embodiments disclosed herein are drawn to methods and systems of an electric over hydraulic controls for livestock handling equipment such as livestock squeeze chutes, large animal rotating tables, and other associated types of livestock confinement equipment. The various embodiments replace the traditional, solely hydraulic systems that control hydraulic cattle squeeze chutes. Controls to operate the primary hydraulic functions and associated equipment of the various embodiments may be operated remotely. For example, various embodiments utilize wired controls (e.g., wired pendant controls) or wireless control devices. The various embodiments may be implemented to provide either an on-demand operating system or a snap-action operating system for livestock handling equipment.

In accordance with various embodiments a hydraulic control system for a livestock restraint apparatus includes a first hydraulic valve configured to be in hydraulic communication with a hydraulic pump, a second hydraulic valve configured to be in hydraulic communication with the hydraulic pump, and a user control unit configured to receive user inputs for controlling the livestock restraint apparatus. First and second solenoids are respectively connected to the first and second hydraulic valves, and the first and second solenoids are electronically coupled to the user control unit. A first hydraulic cylinder is arranged in hydraulic communication with the hydraulic pump via the first hydraulic valve, and a squeeze panel is connected to the first hydraulic cylinder. The panel position of the squeeze panel can then be altered in response to user initiated first control signals sent from the user control unit to the first solenoid.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts a conventional squeeze chute suitable for restraining livestock such as cattle or horses.

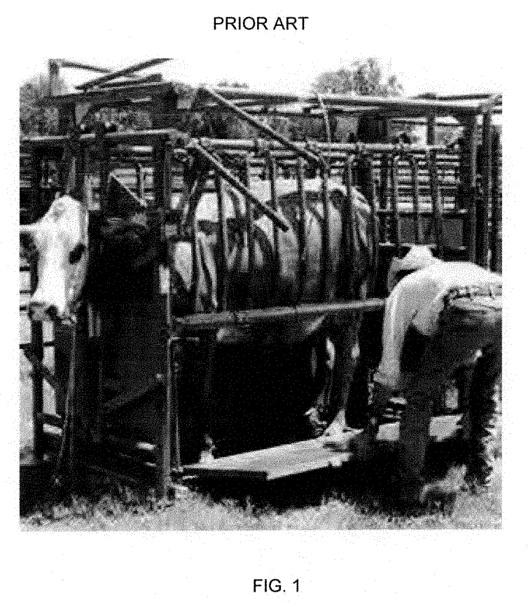

FIG. 2A depicts a block diagram of an on-demand cattle chute hydraulic system according to various embodiments disclosed herein.

FIG. 2B depicts a block diagram of a snap-action squeeze chute hydraulic system according to various embodiments disclosed herein.

FIGS. 3A-B depict side views of a cattle squeeze chute according to various embodiments disclosed herein.

FIGS. 4A-B depict front views of a calf table according to various embodiments disclosed herein.

FIG. 4C depicts a rear view and FIG. 4D depicts a cutaway side view of a calf table according to various embodiments disclosed herein.

FIG. 5 is a flow chart depicting a method of controlling the hydraulic pump of an on-demand livestock handling system according to various embodiments.

FIG. 6 is a flow chart depicting a method of controlling the hydraulic cylinders of a livestock handling system according to various embodiments.

### DETAILED DESCRIPTION

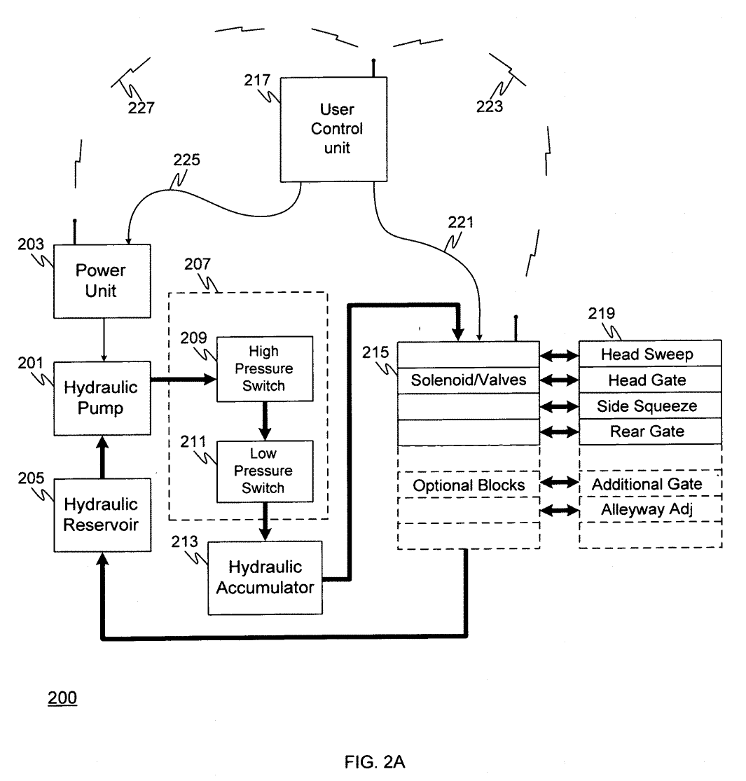

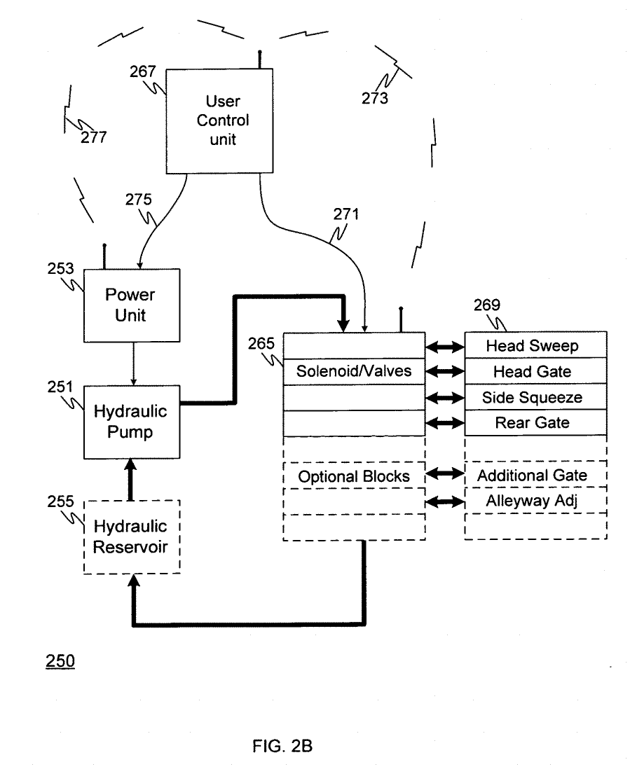

FIG. 2A depicts a block diagram of an on-demand cattle chute hydraulic system 200 according to various embodiments disclosed herein. A cattle squeeze chute is a type of livestock restraint apparatus that allows a user to restrain movement of an animal (e.g., a calf) while performing animal husbandry operations on the animal. The on-demand hydraulic system 200 includes a hydraulic pump 201 mechanically connected to a power unit 203. The power unit 203 is typically an electric motor with a rotating shaft that drives the on-demand hydraulic pump 201. Depending upon the requirements of the implementation and availability of an AC power source the motor may either be an AC motor or a DC motor. In some implementations the power unit 203 may be a combustion engine. One advantage of using an electric motor is that they tend to be much quieter than combustion engines. Loud noises may spook or stress the livestock, making them more difficult to work with. If the on-demand hydraulic system 200 is being used to power a portable cattle chute at a site without AC electrical power, the embodiment may employ an engine driven generator located a prudent distance from the cattle chute to provide either AC or DC electricity. It is easier to run an AC power cord or DC power cord some distance to power an electric motor power unit 203 proximate the hydraulic pump 201 than it is to use long drive shafts to mechanically couple an engine power unit 203 to the hydraulic pump 201. For example, when using the system at a remote pasture the user may employ a 12 volt DC truck battery situated near the cattle chute and run jumper cables to a pickup truck located some distances away (e.g., 50 feet or so) to periodically charge the battery by starting the truck every so often and letting it idle for a while. Alternatively, the user may forego the battery and simply leave the pickup truck idling to power the system.

The hydraulic pump 201 receives hydraulic fluid from hydraulic reservoir 205. Hydraulic reservoir 205 may be positioned adjacent hydraulic pump 201 and connected directly to it, or may be located remote from hydraulic pump 201 (e.g., 200 feet or more away) and connected with hydraulic lines. In some implementations the hydraulic pump 201, hydraulic reservoir 205 and power unit 203 are integrated together as one multicomponent unit. The hydraulic connections (e.g., hydraulic hoses, lines or pipes) are reflected in FIG. 2A by the enlarged arrows, with the arrows showing the normal flow of hydraulic fluid. Hydraulic pump 201 is hydraulically coupled to pump control unit 207 that acts to keep the hydraulic fluid pressure within a predetermined range for operation.

Pump control unit 207 turns the hydraulic pump 201 ON in response to hydraulic fluid pressure falling below a predetermined lower pressure threshold, and OFF in response to hydraulic fluid pressure rising above a predetermined upper pressure threshold. In some embodiments pump control unit 207 may include two hydraulic switches—a high pressure switch 209 and a low pressure switch 211. The high pressure switch 209 turns hydraulic pump 201 OFF in response to hydraulic fluid pressure rising above the predetermined upper pressure threshold. The low pressure switch 211 turns hydraulic pump 201 ON in response to hydraulic fluid pressure falling below the predetermined lower pressure threshold. In other embodiments the hydraulic pump control unit 207 may consist of only a single hydraulic switch that detects the hydraulic fluid pressure reaching its respective upper/lower pressure thresholds, and turns the hydraulic pump 201 OFF/ON accordingly. In yet other embodiments the pump control unit 207 may consist of a pressure indicator in combination with a computer or other controller to send ON/OFF signals to hydraulic pump 201.

In various embodiments pump control unit 207 is hydraulically coupled to a hydraulic accumulator 213. The hydraulic accumulator 213 stores a volume of hydraulic fluid under a predefined pressure. This allows the on-demand system 200 to use pump control unit 207 in an on-demand mode rather than having the pump control unit 207 run all the time or run whenever a gate is closed or an adjustment is made. Running cattle chute hydraulic system 200 in an on-demand mode causes pump control unit 207 to turn ON upon sensing the hydraulic fluid pressure falling below the lower pressure threshold and turn OFF in response to sensing the hydraulic fluid pressure rising above the upper pressure threshold. The on-demand mode is advantageous inasmuch as it saves fuel (or electricity) while also cutting down on noise. The hydraulic accumulator 213 also enables the system to meet surges in pressure demand with a smaller sized hydraulic pump 201 that may not be able to solely provide the volume of hydraulic fluid required during those surges. Hydraulic accumulator 213 also reduces the number of pump start/stop cycles which tend to spook the livestock and interrupt animal husbandry procedures. Despite these advantages, some embodiments may be implemented without hydraulic accumulator 213, as discussed below in conjunction with FIG. 2B. This cuts down on the size of system 200 making it lighter and more easily portable. The hydraulic accumulator 213 may be embodied in any of several types. For example, the hydraulic accumulator 213 may be a piston type accumulator, a bladder type hydraulic accumulator, may use compressed nitrogen, air, or other inert gas, a spring, a weight, or may be any of the various types or designs of hydraulic accumulators known to those of ordinary skill in the art.

The hydraulic accumulator 213 is hydraulically coupled to the system's solenoid/valve blocks 215. Each individual solenoid-valve pair of the solenoid/valve blocks 215 serves as a hydraulic switch that selectively provides hydraulic pressure to one of the various component hydraulic cylinders of the livestock squeeze chute. The solenoid/valve blocks 215 each operate under control of user control unit 217 (sometimes called a wired or wireless control pendant). The user control unit 217 has input devices to receive direction from a user for controlling the position and movement of a livestock restraint apparatus' moving components. The user control unit 217 sends an electrical signal to the solenoid. The user control unit 217 may, in some embodiments, be part of a computer in order to provide computerized control of the solenoid/valve blocks 215. The solenoid, upon being activated, changes the state of the hydraulic valve to open it, close it, or adjust the amount that the valve is open.

The various embodiments of electrical over hydraulic control systems disclosed herein differ considerably from conventional systems that use valve spools of manually operated mechanical hydraulic valves to open and close the various parts of the livestock chute. The user control unit 217 depicted in FIG. 2A is electronically coupled to the solenoid/valve blocks 215 using either a wired line 221 or wireless coupling 223. The user control unit 217 has inputs, or controls, on it for a user to manipulate. For example, the user control unit 217 may have toggle switches, dials, joy sticks, slider switches or other types of electrical switches. The user control unit 217 may be embodied as an app on a smart phone, a computer (e.g., a laptop computer), or a touchscreen on a dedicated control panel. In such embodiments the user control unit 217 may have controls that are manipulated using a computer mouse or the user's fingers on a touch screen. The user control unit 217 may use any combination of these, or other like types of controls known to those of ordinary skill in the art.

The user control unit 217 is also electronically coupled to the power unit 203 using either a wired line 225 or wireless coupling 227 to send user initiated control signals—that is, signals entered by a user on the user control unit 217 for controlling the moving parts of the cattle chute or other livestock restraint apparatus. In some embodiments the user control unit 217 functionality, or part of the functionality, may be provided in the form of an app on a smartphone that is wirelessly connected to the solenoid/valve blocks 215. Through operation of the user control unit 217 a user can turn the system ON or OFF, or selectively open, close or adjust the various parts of the livestock chute. For example, the user can manipulate the user control unit 217 to close the head gate and then may manipulate another of the controls to adjust the side squeeze. Depending upon the particular requirements of the implementation, various controls of the user control unit 217 may be some combination of toggle switches, slider or rotating adjustable switches, joy sticks or electronic equivalents to these on a computer screen or smart phone.

Manipulating a control on the user control unit 217 causes the associated solenoid to activate and open its hydraulic valve, allowing hydraulic fluid to flow to the hydraulic cylinder 219 that controls a hydraulically powered moving part of the livestock chute. The moving parts are the livestock handling components which include, for example, a head sweep, a head gate, one or more side squeeze panels, and a rear gate. Some specialized livestock handing apparatus may be equipped with other hydraulically powered livestock handling components as are known to those of ordinary skill in the art. The head sweep is a part that moves the calf's head to the side (or up or down), pinning it against the structure of the chute. The head gate typically includes two corresponding parts that come together, around the calf's neck to constrain its head and prevent the calf from thrashing around and possibly injuring itself. The squeeze panels, each powered by one or more hydraulic cylinders, come together inward toward each other to squeeze the animal that's within the squeeze chute (e.g., a bull calf or heifer). Some embodiments have a moving squeeze panel on each side of the animal. Other embodiments have one moving squeeze panel that is hydraulically powered to move inward towards a stationary panel on the opposite side.

Some implementations, such as that shown in FIG. 2A, may route the hydraulic return lines back through the solenoid/valve blocks 215. Other implementations may route the hydraulic lines directly back from the various hydraulic cylinders to the hydraulic reservoir 205, completing each hydraulic circuit. Returning the hydraulic fluid back to the hydraulic reservoir 205 helps to avoid overheating the hydraulic fluid since the return fluid—which may be somewhat heated due to circulation—is mixed back with the pool of hydraulic fluid in the hydraulic reservoir 205. Various embodiments disclosed herein use double acting hydraulic cylinders that use hydraulic power to both extend and retract, depending upon the direction of hydraulic fluid flow. Each double acting hydraulic cylinder has two hydraulic lines running to it. So the double ended arrows between the solenoid/valve blocks 215 and the hydraulic cylinder 219 represents a hydraulic line pair.

FIG. 2B depicts a block diagram of a snap-action cattle chute hydraulic system 250 according to various embodiments disclosed herein. The snap-action cattle chute hydraulic system 250 may be used on various types livestock handing apparatus as with the on-demand system 200 described above. The snap-action hydraulic system 250 includes a hydraulic pump 251 mechanically connected to a power unit 253. The power unit 253 may be an electric motor with a rotating shaft that drives the hydraulic pump 251. Depending upon the requirements of the implementation and availability of an AC power source the motor may either be an AC motor or a DC motor. In some implementations the power unit 253 may be a combustion engine. As discussed above, electric motors are advantageous inasmuch as they tend to be quieter than combustion engines. If the snap-action hydraulic system 250 is being used to power a portable cattle chute at a site without AC electrical power, the embodiment may employ an engine driven generator.

The hydraulic pump 251 may receive hydraulic fluid from a hydraulic reservoir 253. Some implementations may eliminate the hydraulic reservoir 253 (as indicated by the dotted line), or provide a hydraulic reservoir 253 of a minimal size to lighten the weight and volume of the snap-action hydraulic system 250. The snap-action hydraulic system 250 typically does not have a pump control unit 207 or hydraulic accumulator 213 as shown in FIG. 2A. Instead the hydraulic pump 251 starts each time hydraulic pressure is needed to open, close or adjust a component of the chute system. In this respect the snap-action hydraulic system 250 differs in operation from the on-demand hydraulic system 200 described above in conjunction with FIG. 2A. Eliminating the pump control unit 207 and hydraulic accumulator 213 cuts down on the size and weight of system 250, making it lighter and easier to move to remote pastures or even rodeo and fairground sites.

The hydraulic pump 251 of the snap-action hydraulic system 250 is hydraulically coupled to the system's solenoid/valve blocks 265. The solenoid/valve blocks 265 operate in a manner similar to that described above for solenoid/valve blocks 215 shown in FIG. 2A. Each individual solenoid-valve pair in the solenoid/valve blocks 265 serves as a hydraulic switch that selectively provides hydraulic pressure to the various component hydraulic cylinders 269 of the livestock squeeze chute. The solenoid/valve blocks 265 each operate under control of user control unit 267. The user control unit 217 has input devices to receive direction from a user for controlling the position and movement of a livestock restraint apparatus' moving components. The user control unit 267 may be configured similarly to user control unit 217 disclosed above in conjunction with FIG. 2A.

This electrical over hydraulic control system differs from conventional systems that use manually operated mechanical hydraulic valves to open and close the various parts of the livestock chute. The user control unit 267 is electronically coupled to the solenoid/valve blocks 265 using either a wired line 271 or wireless coupling 273. The user control unit 267 is also electronically coupled to the power unit 253 using either a wired line 275 or wireless coupling 277 to send user initiated control signals—that is, signals entered by a user on the user control unit 267 for controlling the moving parts of the cattle chute or other livestock restraint apparatus. In some embodiments the user control unit 267 functionality, or part of the functionality, may be provided in the form of an app on a smartphone that is wirelessly connected to the solenoid/valve blocks 265. Through operation of the user control unit 267 a user can turn the system ON or OFF, or selectively open, close or adjust the various parts of the livestock chute. For example, the user can manipulate the user control unit 267 to close the head gate and then may manipulate another of the controls to adjust the side squeeze. Depending upon the particular requirements of the implementation, various controls of the user control unit 267 may be some combination of toggle switches, slider or rotating adjustable switches, joy sticks or electronic equivalents to these on a computer screen or smart phone.

Manipulating a control on the user control unit 267 causes the associated solenoid to activate and open its hydraulic valve, allowing hydraulic fluid to flow to the hydraulic cylinder 267 that controls a part of the livestock chute. Depending upon the implementation, the return lines may be either routed back through the solenoid/valve blocks 265, as shown in FIG. 2B, or may be routed directly back to the hydraulic pump 251 (or hydraulic reservoir 255, if so equipped).

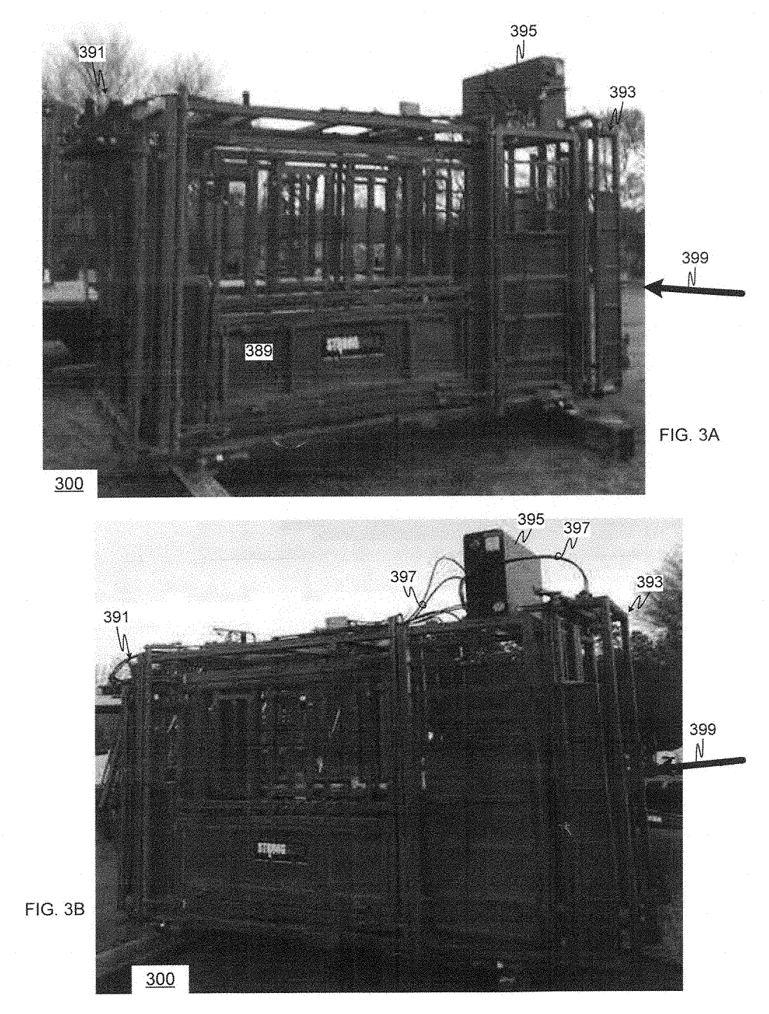

FIGS. 3A-B depict side views of a cattle squeeze chute 300 according to various embodiments disclosed herein. The cattle squeeze chute 300 has a head gate 391 at the front and a rear gate 393 at the back. Some embodiments also have a head sweep mechanism that restrains the animal's head to the side to keep it from jerking back and forth and/or up and down, and keep the animal from injuring itself or the user. Some implementations of the head sweep mechanism may pin the animal's head up or down. The cattle squeeze chute 300 has a squeeze panel 389 on each side. The squeeze panels 389 are powered by one or more hydraulic cylinders to move inward toward each other to squeeze the animal that's within the chute (e.g., a bull calf or heifer). Some embodiments have a moving squeeze panel 389 on each side of the animal. Other embodiments have one moving squeeze panel 389 that is hydraulically powered to move inward towards a stationary panel on the opposite side.

A calf—e.g., a bull, heifer or steer—enters rear gate 393 in direction 399. The squeeze chute 300 depicted in FIGS. 3A-B is dimensioned for cattle. However, by altering various dimensions to be larger or smaller, and using materials of appropriate strength, other implementations of squeeze chutes may be tailored for virtually any type of livestock or four legged animal. The concepts used in the various embodiments disclosed herein may be applied to livestock handling equipment for horses, sheep, hogs, buffalo, dogs, or any other like type of four legged animal known to those of ordinary skill in the art that may require animal husbandry procedures or medical care.

Turning to FIG. 3B, the system enclosure box 395 can be seen sitting atop the squeeze chute 300. In practice, system enclosure 395 need not be a box but may be any number of other shapes, e.g., a cylinder, a platform, an open framework, etc. Depending upon the particular requirements of the implementation the system enclosure box 395 may be positioned in other locations on or near the squeeze chute 300 or oriented in a different manner. For example, the system enclosure box 395 may be located towards the front of squeeze chute 300 rather than near the rear, or the system enclosure box 395 may be laid on its side, providing a lower profile, rather than sitting upright as shown in the figures. The system enclosure box 395 may alternately be located along side the squeeze chute 300, or even underneath the floor of the squeeze chute 300 in some implementations. Moreover, the system enclosure box 395 need not be affixed to the squeeze chute 300 itself. Instead, the system enclosure box 395 in some implementations may be located some distance away—e.g., within 100 feet—and be connected by wired or wireless coupling and hydraulic lines.

Typically the system enclosure box 395 contains a number of the components depicted in the block diagram of FIG. 2A. The power unit, hydraulic pump, hydraulic reservoir, high and low pressure switches, hydraulic accumulator and solenoid/valve block may be positioned within the system enclosure box 395. However, it is not a requirement that all of these components be located within the system enclosure box 395. According to various designs one or more of them may be positioned elsewhere and connected or coupled to the system as shown in FIG. 2A.

FIG. 3B shows a number of hydraulic lines 397 extending system enclosure box 395. Each of the hydraulic lines 397 extends from the system enclosure box 395 to one of the hydraulic cylinders used to move the components of the cattle squeeze chute 300. Various embodiments of the cattle squeeze chute 300 use double acting hydraulic cylinders that are powered to push and pull, depending upon the direction of hydraulic fluid flow. Each double acting hydraulic cylinder has two hydraulic lines running to it. Other implementations need not use double acting hydraulic cylinders for every moving component of the squeeze chute. Instead one or more of the hydraulic cylinders may be implemented as a single acting hydraulic cylinder with one direction of shaft movement being accomplished with a spring.

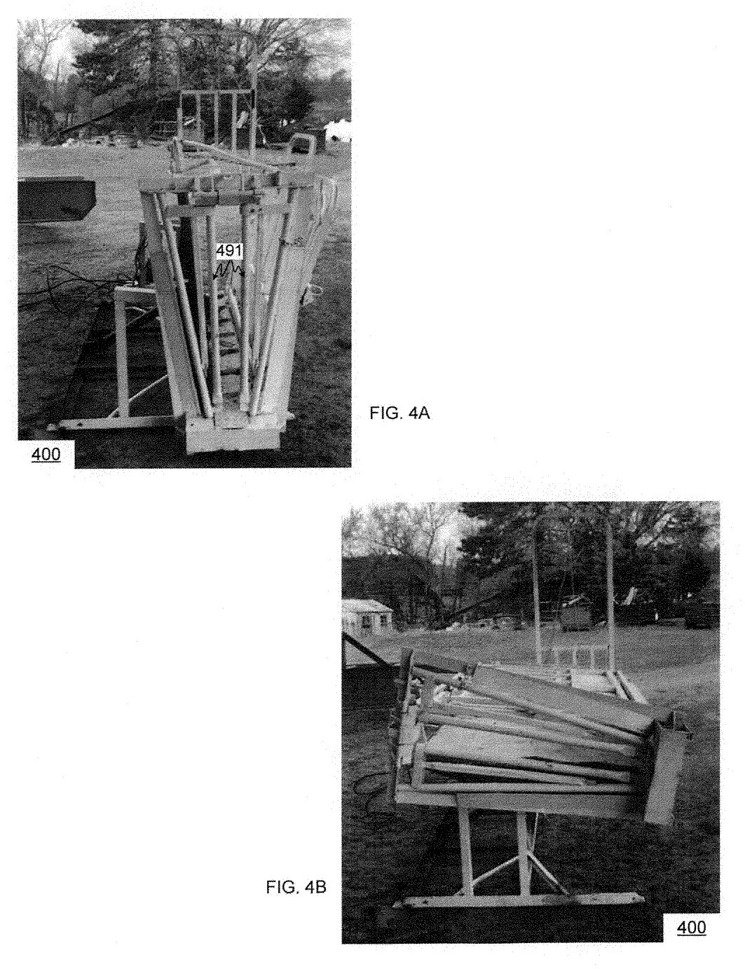

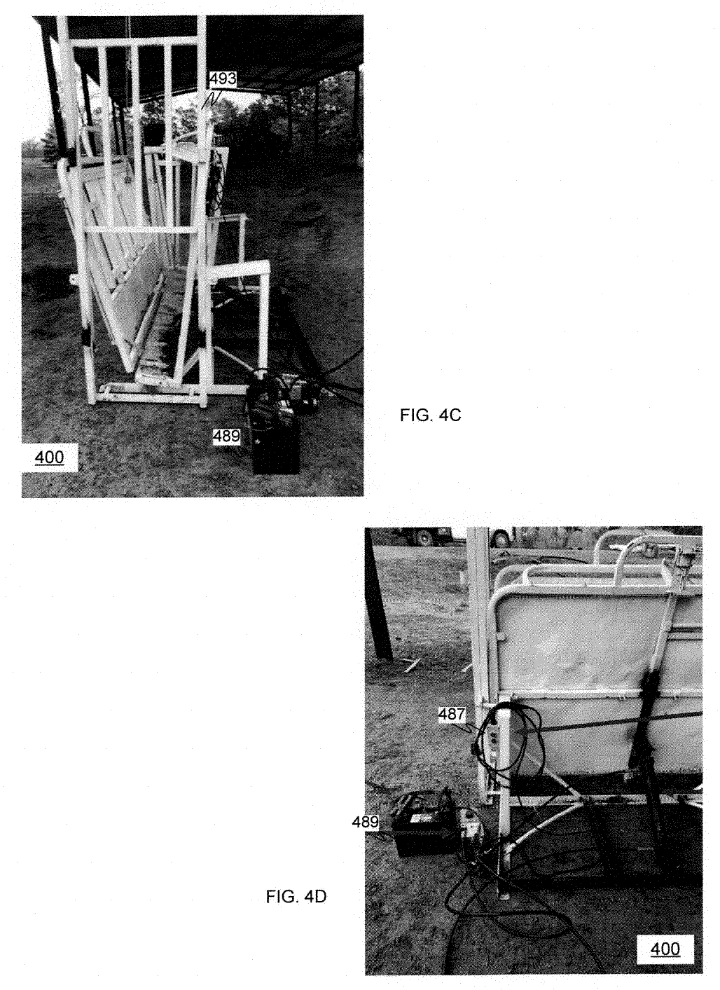

FIGS. 4C-4D depict two views a calf table 400 according to various embodiments disclosed herein. A calf table is similar to a squeeze chute, but with additional mechanism that allows the chute to be rotated so the animal is laid on its side. Various embodiments of calf tables may have all, or some, of the functionality of a squeeze chute, but with the added functionality of being able to rotate into a table position to lay the animal flat on its side. Calf tables are useful for restraining a calf or other type of livestock so as to expose its belly or lower portions. Calf tables are useful are useful to veterinarians and ranchers for performing various procedures, including for example, castration. FIG. 4A depicts the calf table in its upright position. A calf walks or is driven through the rear gate 393 (shown in FIG. 4C), and the user captures and restrains the calf s head with the head gate 491 and manipulates the side panel to squeeze the animal from the sides. Once the calf is restrained the calf table can be rotated into the table position as shown in FIG. 4B. Typically, the calf table is designed so that a portion of the side panel can be opened, allowing better access to the animal being cared for.

FIG. 4C depicts the back end of the calf table 400, showing its rear gate 493 that raises up to allow entry by the animal. Once the animal enters the calf table 400 the rear gate 493 is lowered and the squeeze chute is activated. FIGS. 4C-D depicts a battery 489 used to power the hydraulic pump. FIG. 4D shows a control unit 487 used to rotate the calf table 400 into the table position.

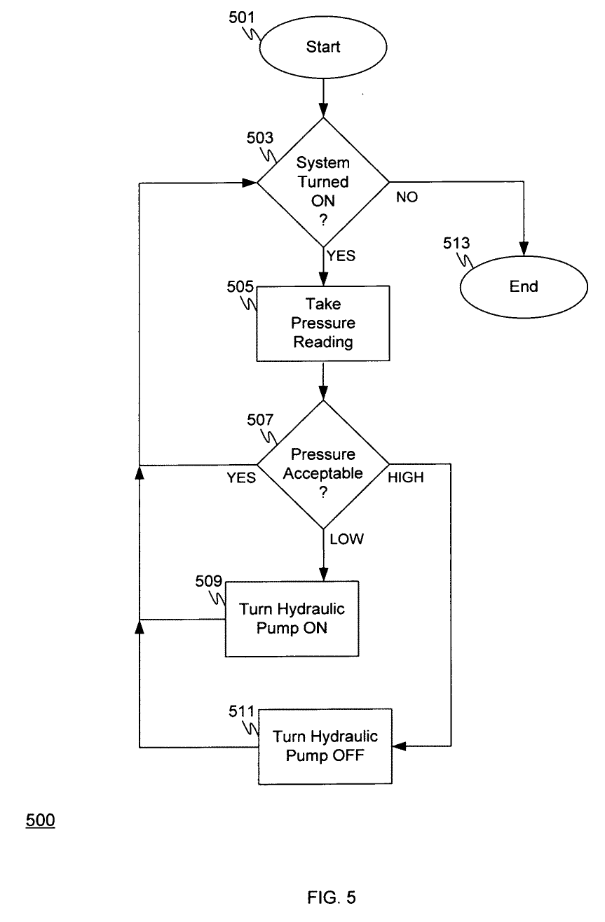

FIG. 5 is a flow chart depicting a method 500 of controlling the hydraulic pump of an on-demand livestock handling system according to various embodiments. The livestock handling system may be a cattle or other large animal squeeze chute, a livestock rotation table, or other livestock handling system using hydraulic cylinders for controlled motion of its components. The method starts at block 501 and proceeds to block 503 to determine whether or not the system is turned ON. If the system is turned ON the method proceeds along the “YES” branch to block 505 to take a pressure reading. In some embodiments the pressure reading may be taken by an actual pressure gauge or pressure indicator device. Other embodiments—for example the embodiment depicted in FIG. 2A—may use a high pressure switch and a low pressure as a means of monitoring the pressure. The method proceeds to block 507, and if the pressure indication is a predetermined acceptable range, the method proceeds along the “YES” branch looping back to block 503.

For the embodiment of FIG. 2A with the high and low pressure switches the predetermined acceptable range would occur if the detected pressure is lower than the upper threshold and above the lower threshold. At detected pressures above the upper threshold the method proceeds along “HIGH” path to block 511 and the high pressure switch turns the hydraulic pump OFF. At detected pressures below the lower threshold the method proceeds along “LOW” path to block 509 and the low pressure switch is activated to turn the hydraulic pump ON. For embodiments shown in FIG. 2A with a pump control unit 207 consisting of a pressure indicator in combination with a computer or other controller, the pump control unit 207 send an ON signal to hydraulic pump 201 if the detected pressure is below the lower threshold, and sends an OFF signal to hydraulic pump 201 if the detected pressure is above the upper threshold.

Once the method proceeds from block 507 through one of the HIGH, LOW or YES paths, the method loops back to block 503 to again determine whether system remains turned ON or has been turned OFF. In practice, once the system is turned OFF the method proceeds from whatever block is being performed to block 513 where the method ends.

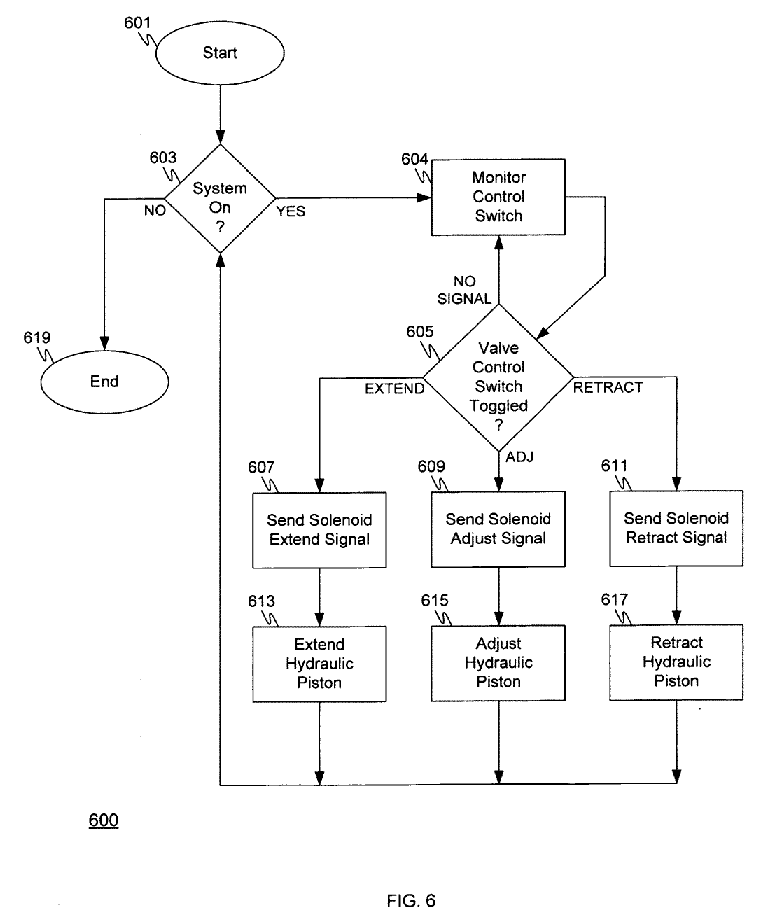

FIG. 6 is a flow chart depicting a method 600 of controlling the hydraulic cylinders of a livestock handling system according to various embodiments. The livestock handling system may be a cattle or other large animal squeeze chute, a livestock rotation table, or other livestock handling system using hydraulic cylinders for controlled motion of its components. The method begins at block 601 and proceeds to 603 to determine whether the system is ON. If the system is powered ON and running the method proceeds from block 603 to block 604 monitor the control unit to determine whether a control signal has been sent, and then proceeds to block 605.

In block 605 the method determines how to handle the control signal, if any has been detected. The user has manipulated a control that closes a head gate, tightens the squeeze chute, or otherwise requires a hydraulic cylinder to be extended, the method proceeds along the “EXTEND” path to block 607 where a signal is sent to the solenoid block to extend the indicated hydraulic cylinder. In response, the appropriate hydraulic cylinder is extended in block 613 and the method loops back to block 603. Returning to block 605, if the user has manipulated a control that opens a head gate, loosens the squeeze chute, or otherwise requires a hydraulic cylinder to be retracted, the method proceeds along the “RETRACT” path to block 611 where a signal is sent to the solenoid block to retract the indicated hydraulic cylinder. In response, the appropriate hydraulic cylinder is retracted in block 617 and the method loops back to block 603.

Some embodiments are implemented with progressive controls that allow adjustment of the hydraulic cylinders to intermediate positions. This is useful, for example, to position the squeeze chute to an intermediate position or apply a proportional amount of squeeze chute pressure based on the control lever position manipulated by the user. Returning to block 605, if the system detects a progressive control signal from the user the method proceeds along the “ADJ” path to block 609 where a signal is sent to the solenoid block to adjust the indicated hydraulic cylinder in the desired manner. In response, the appropriate hydraulic cylinder is retracted, extended or otherwise adjusted in block 617 to the degree controlled by the user, and the method loops back to block 603.

If block 605 does not detect any control signal from the user the method loops back via the “NO SIGNAL” path to block 604 to again monitor for a user control signal. In block 603 if it is determined that the system has been turned OFF the method proceeds to block 619 and ends. In practice, once the system is turned OFF the method proceeds from whatever block is being performed to block 619 where the method ends.

Various activities may be included or excluded as described above, performed in a different order, or performed concurrently, as would be known by one of ordinary skill in the art, while still remaining within the scope of at least one of the various embodiments. For example, the pressure reading taken in block 505 of FIG. 5 may be performed concurrently with determining in block 507 that the pressure level too high. The steps 505 and 507 are performed concurrently in the FIG. 2A embodiment with a pair of hydraulic pressure switches 209-211 in the situation where high pressure switch 209 indicates the pressure is above the predetermined upper pressure threshold. Further, although FIG. 6 depicts the method proceeding from block 603 to block 619 to end, once the system is turned OFF the method proceeds from whatever block is being performed to block 619 and the method ends.

The term “livestock restraint apparatus” includes livestock squeeze chutes, calf tables (sometimes called livestock rotation tables), livestock head gates and various other types of hydraulically powered livestock handling equipment for restraining livestock or other animals as are known to those of ordinary skill in the art. For the sake of brevity this disclosure refers to cattle squeeze chutes and calf tables. However, the various embodiments may be implemented in a number of different types of livestock restraint apparatus. The cattle squeeze chutes and calf tables may be configured for use with cattle, horses, mules, sheep, goats, hogs, buffalo, dogs, and zoo animals or aquatic animals such as zebra, cape buffalo, camels, manatees or other types of livestock, zoo animals or aquatic animals known to those of ordinary skill in the art. This disclosure mentions use of 110 volt AC and 12 volt DC electricity to power a motor. However, the various embodiments may be adapted to use 220 volt AC, 6 volt DC or any other known level of AC or DC electricity known to those of ordinary skill in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “plurality,” as used herein and in the claims, means two or more of a named element, object or step. It should not, however, be interpreted to necessarily refer to every instance of the named thing in the entire device. Particularly, if there is a reference to “each” element of a “plurality” of elements. There may be additional elements, objects or steps in the entire apparatus or method that are not to be included in the “plurality” and are not, therefore, referred to by “each.”

The word “substantially” (e.g., substantially vertical or substantially one foot) as used herein in the specification and claims is meant to mean plus or minus as much as 2%. For example, substantially one foot as used herein means any length within the range of 1 foot+/−0.02 foot. Similarly, an angle of 10 degrees as used herein means any angle within the range of 10 degrees+/−0.2 degree. The word “approximately” as used herein means the same as the word “substantially.” The phrase “slightly less than” as used herein, is defined to mean at least 98% of. For example, an outside diameter of a hydraulic piston that is slightly less than the hydraulic cylinder's inside diameter means that the piston's diameter is at least 98% of the cylinder's inside diameter. The phrase “back and forth” as used herein describing the motion of a first part relative to a second part means that the first part moves one way (e.g., distal direction) relative to the second part, and then moves the other way (e.g., proximal direction) relative to the second part. For example, a hydraulic piston that moves back and forth within a hydraulic cylinder moves towards the distal end of the cylinder, then changes direction to move toward the proximal direction of the cylinder.

Two components that are in “hydraulic communication” with each other—as this phrase is used herein including in the claims—means that hydraulic fluid passes between the two components (e.g., Lube King Premium Universal Trans-Hydraulic Fluid). Two components may be in hydraulic communication if there is a line of hydraulic fluid between the two components, e.g., if they are connected by a hydraulic line—often a rubber or synthetic hose reinforced by steel mesh. A first component may be in hydraulic communication with a second component via a third component. For example, the squeeze panel hydraulic cylinder is in hydraulic communication with the hydraulic pump via a hydraulic valve operated by a solenoid. The phrase “hydraulically connected” means the same as “in hydraulic communication.” More than two components can be “in hydraulic communication” (or be hydraulically connected). For example, some embodiments of cattle squeeze chute 300 depicted in FIGS. 3A-B may be equipped with a hydraulic cylinder on each side of head gate 391, and both of the head gate hydraulic cylinders may be in hydraulic communication with the hydraulic valve in the solenoid/valve block, e.g., solenoid/valve blocks 215 of FIG. 2A.

The term “electronically coupled” means that two components are either coupled via a wire (“hard-wired”) or wirelessly coupled. Two components—a first component and a second component—are coupled via a wire if an electrical signal or electric current can be sent from the first component through the wire (and possibly through one or more intermediate components) to the second component. Two components—a first component and a second component—are wirelessly coupled if a wireless electrical signal can be sent from the first component through the air to the second component. For example, the user control unit 217 of FIG. 2A is electronically coupled to the solenoids in the solenoid/valve block 215 so as to pass control signals to the solenoids which in turn operate (turn ON/OFF) their associated hydraulic valves. The user control unit 217 may either be wirelessly coupled via wireless coupling 223 or may be hard-wired via wired line 221. A “user initiated control signal” is an electronic signal either sent wirelessly or over a hardwired line in response to the user manipulating an input, e.g., toggling a toggle switch, moving a slider or joystick, pressing an input on a smartphone, or the like. A component, e.g., a solenoid, is said to receive the user initiated control signal even though the signal may pass through one or more intermediate devices such as a receiver. So long as the component is controlled in a predetermined manner (e.g. movement of a solenoid) in response to the user initiated control signal being sent, the component is said to receive the user initiated control signal.

The corresponding structures, materials, acts, and equivalents of all means or step plus function elements, if any, in the claims below are intended to include any structure, material, or act for performing the function in combination with other claimed elements as specifically claimed. This disclosure of the various embodiments has been presented for purposes of illustration and description, and is not intended to be exhaustive in the form disclosed. Many modifications and variations will be apparent to those of ordinary skill in the art without departing from the scope and gist of the invention. The various embodiments included herein were chosen and described in order to best explain the principles of the invention and the practical application, and to enable others of ordinary skill in the art to understand the invention for various embodiments with various modifications as are suited to the particular use contemplated. The description of the various embodiments provided above is illustrative in nature inasmuch as it is not intended to limit the invention, its application, or uses. Thus, variations that do not depart from the intents or purposes of the invention are encompassed by the various embodiments of the present invention. Such variations are not to be regarded as a departure from the intended scope of the present invention.

What is claimed is:

1. A hydraulic control system for a livestock restraint apparatus comprising:
a first hydraulic valve in hydraulic communication with a hydraulic pump;
a second hydraulic valve in hydraulic communication with the hydraulic pump;
a user control unit configured to receive user inputs for controlling the livestock restraint apparatus;
a first solenoid connected to the first hydraulic valve, wherein the first solenoid is electronically coupled to the user control unit;
a second solenoid connected to the second hydraulic valve; wherein the second solenoid is electronically coupled to the user control unit;
a first hydraulic cylinder in hydraulic communication with the hydraulic pump via the first hydraulic valve;
wherein a squeeze panel is connected to the first hydraulic cylinder, a panel position of the squeeze panel being altered in response to first control signals sent from the user control unit to the first solenoid.

2. The hydraulic control system of claim 1, wherein the user control unit is wirelessly coupled to the first solenoid and to the second solenoid, the system further comprising:
a solenoid/valve block configured to include the first solenoid, the first hydraulic valve, the second solenoid and the second hydraulic valve; and
a hydraulic reservoir in hydraulic communication with the hydraulic pump and the solenoid/valve block.

3. The hydraulic control system of claim 1, wherein the first control signals are user initiated control signals.

4. The hydraulic control system of claim 1, further comprising:
a second hydraulic cylinder in hydraulic communication with the hydraulic pump via the second hydraulic valve; and
a head gate connected to the second hydraulic cylinder, wherein a gate position of the head gate is altered in response to second control signals sent from the control unit to the second solenoid.

5. The hydraulic control system of claim 1, further comprising:
a third hydraulic valve in hydraulic communication with the hydraulic pump;
a third solenoid connected to the third hydraulic valve; wherein the third solenoid is electronically coupled to the user control unit;
a third hydraulic cylinder in hydraulic communication with the hydraulic pump via the third hydraulic valve; and
a rear gate configured to open and close in response to a third control signal sent from the control unit to the third solenoid.

6. The hydraulic control system of claim 2, further comprising:
a hydraulic accumulator hydraulically connected between the solenoid/valve block and the hydraulic pump.

7. The hydraulic control system of claim 6, further comprising:
a pump control unit, wherein the hydraulic accumulator is in hydraulic communication with the hydraulic pump via the pump control unit.

8. The hydraulic control system of claim 7, wherein the pump control unit comprises:
a high pressure switch configured to turn the hydraulic pump off in response to hydraulic fluid pressure rising above a predetermined upper pressure threshold; and
a low pressure switch configured to turn the hydraulic pump on in response to the hydraulic fluid pressure falling below a predetermined lower pressure threshold.

9. A method of hydraulically controlling a livestock restraint apparatus, the method comprising:
connecting a first hydraulic valve to be in hydraulic communication with a hydraulic pump;
connecting a second hydraulic valve to be in hydraulic communication with the hydraulic pump;
providing a user control unit configured to receive user inputs for controlling the livestock restraint apparatus;
electronically coupling a first solenoid to the user control unit, the first solenoid being connected to the first hydraulic valve;
electronically coupling a second solenoid to the user control unit, the second solenoid being connected to the second hydraulic valve;
providing a first hydraulic cylinder in hydraulic communication with the hydraulic pump via the first hydraulic valve;
sending first control signals from the user control unit to the first solenoid; and
altering a panel position of a squeeze panel connected to the first hydraulic cylinder in response to the first control signals.

10. The method of claim 9, wherein the user control unit is wirelessly coupled to the first solenoid and to the second solenoid, the method further comprising:
providing a solenoid/valve block that includes the first solenoid, the first hydraulic valve, the second solenoid and the second hydraulic valve; and
connecting a hydraulic reservoir to be in hydraulic communication with the hydraulic pump and the solenoid/valve block.

11. The method of claim 9, wherein the first control signals are user initiated control signals.

12. The method of claim 9, further comprising:
providing a second hydraulic cylinder in hydraulic communication with the hydraulic pump via the second hydraulic valve; and
connecting a head gate to the second hydraulic cylinder, wherein a gate position of the head gate is altered in response to second control signals sent from the control unit to the second solenoid.

13. The method of claim 9, further comprising:
providing a third hydraulic valve in hydraulic communication with the hydraulic pump;
electronically coupling a third solenoid to the user control unit, the third solenoid being connected to the third hydraulic valve;
providing a third hydraulic cylinder to be in hydraulic communication with the hydraulic pump via the third hydraulic valve; and
configuring a rear gate to open and close in response to a third control signal sent from the control unit to the third solenoid.

14. The method of claim 10, further comprising:
providing a hydraulic accumulator to be hydraulically connected between the solenoid/valve block and the hydraulic pump.

15. The method of claim 14, further comprising:
providing a pump control unit, wherein the hydraulic accumulator is in hydraulic communication with the hydraulic pump via the pump control unit.

16. The method of claim 15, further comprising:
configuring, as part of the pump control unit, a high pressure switch that turns the hydraulic pump off in response to hydraulic fluid pressure rising above a predetermined upper pressure threshold; and
configuring, as part of the pump control unit, a low pressure switch that turns the hydraulic pump on in response to the hydraulic fluid pressure falling below a predetermined lower pressure threshold.
